(19) United States
(12) Patent Application Publication
(10) Pub. No.: US 2006/0166618 A1
(43) Pub. Date: Jul. 27, 2006

(54) Adaptive relay management

(75) Inventor: Byron Bakaimis, Staines (GB)

Correspondence Address: DILWORTH & BARRESE, LLP, 333 EARLE OVINGTON BLVD., UNIONDALE, NY, 11553, US

(73) Assignee: Samsung Electronics (UK) Ltd., Chertsey (GB)

(21) Appl. No.: 11/318,167

(22) Filed: Dec. 23, 2005

(30) Foreign Application Priority Data
Dec. 23, 2004 (GB) 0428271.1

(51) Int. Cl. H04B 7/15

(52) U.S. Cl. 455/11.1

(57) ABSTRACT

A method of controlling a plurality of relays in communication with a base station in a cell. The controlling method comprises the steps of evaluating usage requirements in a cell, and varying the number and/or type of relays used in order to meet the usage demands based on the evaluation.

The present invention relates to an adaptive relay management method and particularly an adaptive relay management method for use with a cellular mobile telephone network.

In mobile telecommunication systems, a mobile terminal (e.g. a mobile phone) is used to access a telecommunications network. The network essentially comprises two main systems: a network switching system and a base station.

The network switching system comprises a plurality of network switching centres, which act as ‘gateways’ that provide interconnections to other mobile and fixed networks.

The base station is effectively divided into a plurality of elements. Two of these elements are the base station controller and the base transceiver station. The base station's area of responsibility is determined by the radio coverage achieved from the transceiver site, and this area will generally cover a large number of mobile terminals.

The base transceiver station controls all radio functions associated with transmission to, and reception from, mobile terminals.

The base station controller controls the base transceiver station. In practice the base station controller will control a plurality of base transceiver stations.

As will be appreciated by those skilled in the art, the cost of construction of a base transceiver station is significant. Thus, in order to minimize cost and maximise coverage, relays are used within the network. Relays are operable to receive and transmit signals from a mobile terminal to the base transceiver station and vice versa. Thus, relays allow for additional coverage from what otherwise would be the case with just a base transceiver station.

Relays may also be used in areas of poor coverage, or if there is an occasional concentration of mobile terminals—for example at a football match.

Current relays are generally fixed in areas to help overcome shadowed areas—for example due to large buildings. Relays are also used to extend coverage outside the range of the base transceiver station.

In a given network, many different types of relay may be used. Possible forms of mobile relays could comprise further mobile phones, lap-top computers or PDAs. The use of (e.g.) mobile phones and PDAs has advantages that these devices generally already have a degree of in-built functionality that may be utilized in a network. A drawback is the drain on the battery power of the mobile device.

Alternatively, purpose built relays may be used. This arrangement overcomes the drawback of draining battery power. However, there are costs associated with the construction and installation of the relay.

It would be desirable to improve current systems, and particularly to be able to provide a more comprehensive coverage, whilst maintaining efficient performance.

According to a first aspect of the present invention there is provided a method of controlling a plurality of relays in communication with a base station in a cell, wherein said method comprises the steps of evaluating usage requirements in a cell, and varying the relays used in order to meet the usage demands based on the evaluation.

It is preferred that the capabilities and availability of the relays are also used when determining which relays are to be used to meet the usage demands in the cell.

Preferably at least some of the relays are terrestrial based and are moveable with respect to the base station.

Preferably at least some of the relays are mounted onto a vehicle, and preferably a vehicle associated with a pre-set route and schedule. Buses, coaches and trains are most preferred as these vehicles generally follow a set time-table and route, and hence their location is generally known, or at least can be estimated.

Preferably at least one of the mobile relays comprises a user terminal.

It is preferred that a plurality of scenarios are predetermined, and the most appropriate relays for each scenario are pre-selected.

In a preferred first general embodiment, the means to assess the capabilities of the relays is located at the base station, and possibly at the base transceiver station. However, it is equally preferred that the means to assess the capabilities of the relays is located at a base station controller.

In a preferred general second embodiment it is preferred that each individual relay assesses its own capabilities.

In the first general embodiment it is preferred that each relay in the network is classified according to capability, wherein, during initial communication with a base station each relay communicates data indicative of its classification to the base station.

It is preferred that the number of relays used in the network may be altered based on changes to any or all of the cell usage requirements, relay capabilities and relay availability.

Preferably the capabilities of each of the relays within the cell are assessed periodically. It is particularly preferred that the capabilities of each of the relays are assessed at predetermined intervals. Alternatively, or as well as, it is preferred that the capabilities of each of the relays are assessed based on external triggers. Preferably the external trigger is the joining or leaving of a relay within the cell.

In the second general embodiment it is preferred that the base station broadcasts a signal on a channel receivable by each of the relays, said signal including an evaluation of current usage requirements. It is particularly preferred that the signal broadcast to the relays defines a pre-defined scenario. Thus, each individual relay may compare their capabilities with the evaluation of current requirements.

It is preferred that if a relay assesses that it is suitable for use in the network it registers with the base station. In a particularly preferred embodiment the base station broadcasts the preferred number of relays for use in a particular scenario, and only permits that number of relays to register.

In a particularly preferred embodiment the network assigns weighting factors for relay characteristics. Accordingly, when each relay assesses their capabilities with those that are required, the more important elements may be emphasised.

In a further preferred embodiment each relay compares its characteristics with those required for a set of pre-determined scenarios. Preferably a hierarchical list is made for each scenario. This arrangement allows for the most appropriate relays to be selected for a given scenario, and further provides details of the next most suitable relay, should the most suitable become unavailable. Accordingly, a set of relays from the currently active relays in the cell is effectively pre-selected for each scenario. However, multiple contingency plans are built into each scenario as each relay is hierarchically listed the ‘next best’ relay is always known. In a preferred embodiment the location of the relays in the cell is determined, and it is further preferred that the relays' location is a factor in at least one of the predetermined scenarios.

According to a second aspect of the present invention there is provided a mobile telecommunications network operable to function according to any aspect of the above recited method.

According to a third aspect of the present invention there is provided a mobile telecommunications network comprising at least one mobile relay mounted upon a terrestrial vehicle.

Preferably the transport is a bus, coach or train. However, any form of transport, such as a car, may be used.

In order that the present invention be more readily understood, specific embodiments thereof will now be described with reference to the accompanying drawings.

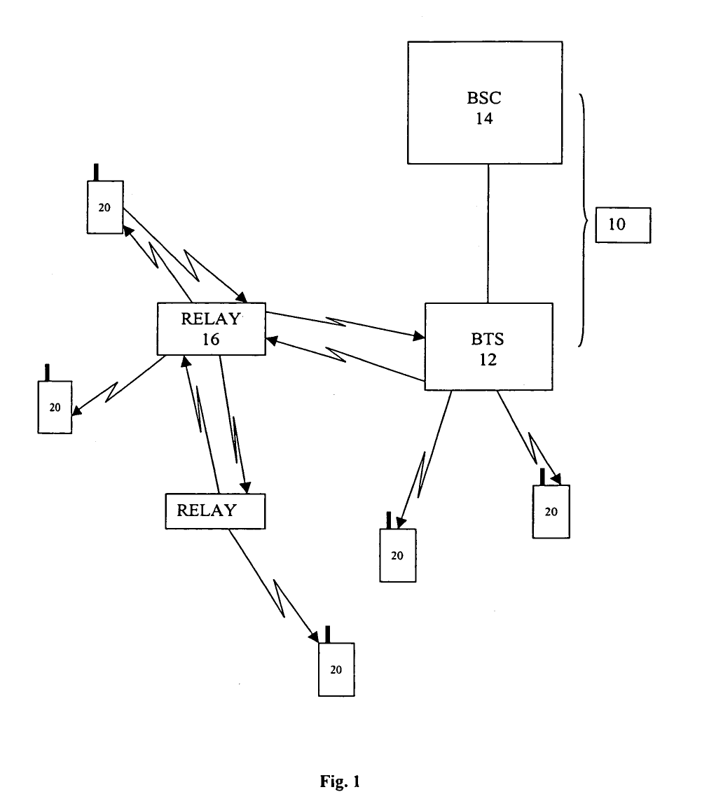

FIG. 1 shows an example of a mobile telecommunications network.

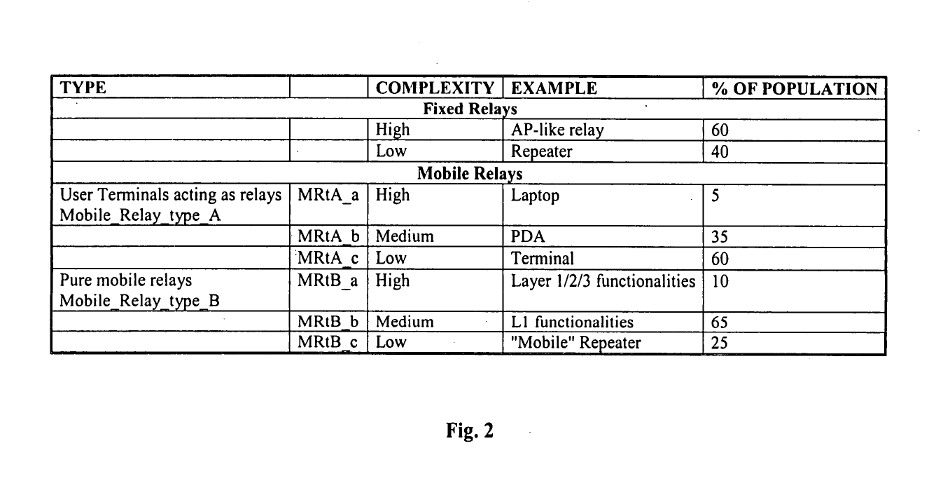

FIG. 2 is a table showing an example of how relays may be identified and classified according to a first embodiment.

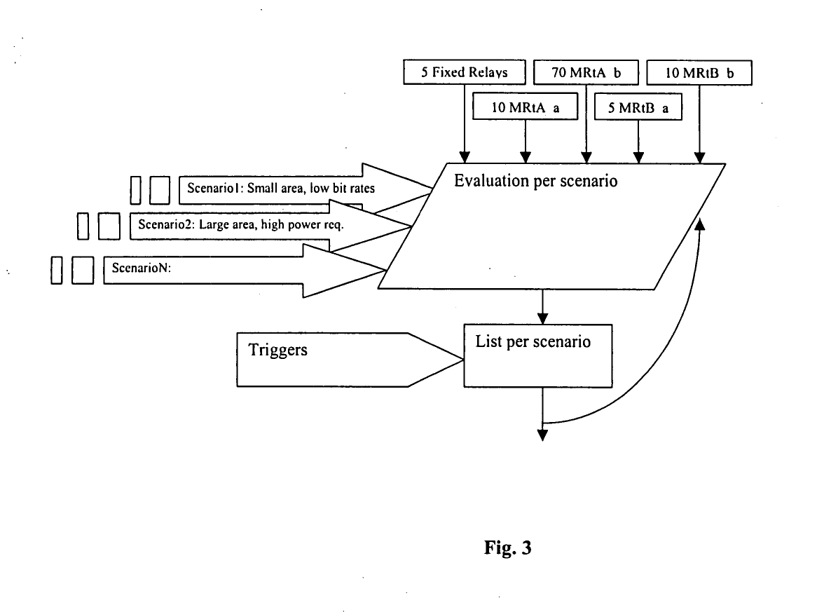

FIG. 3 shows an example of how the most optimum relays are evaluated for each scenario according to a first embodiment.

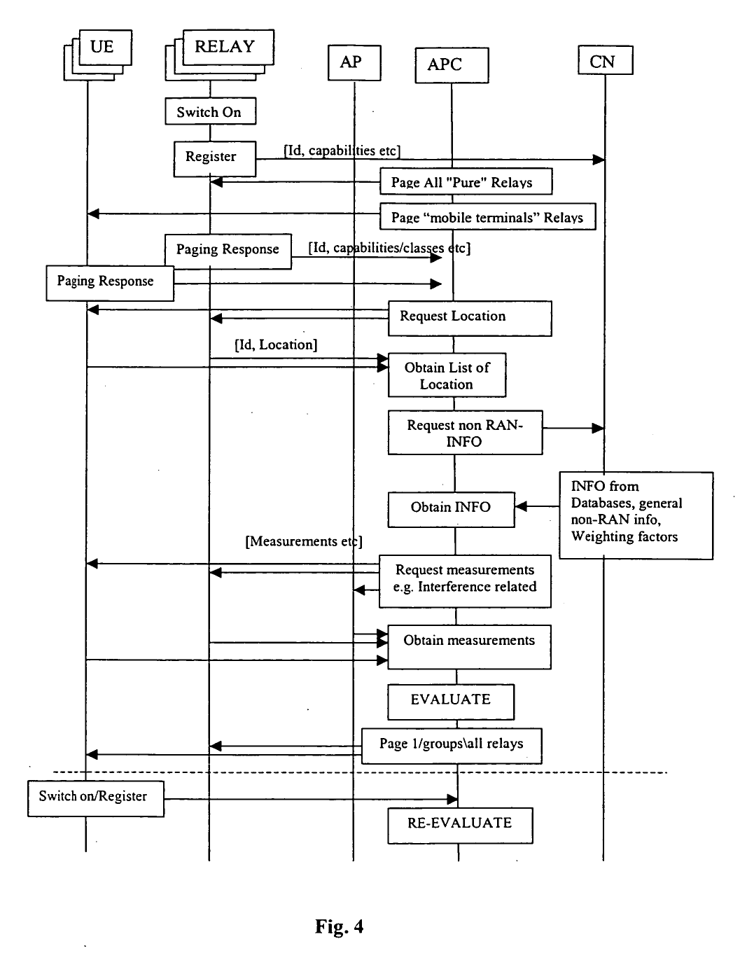

FIG. 4 illustrates a base station controller signalling function according to a first embodiment.

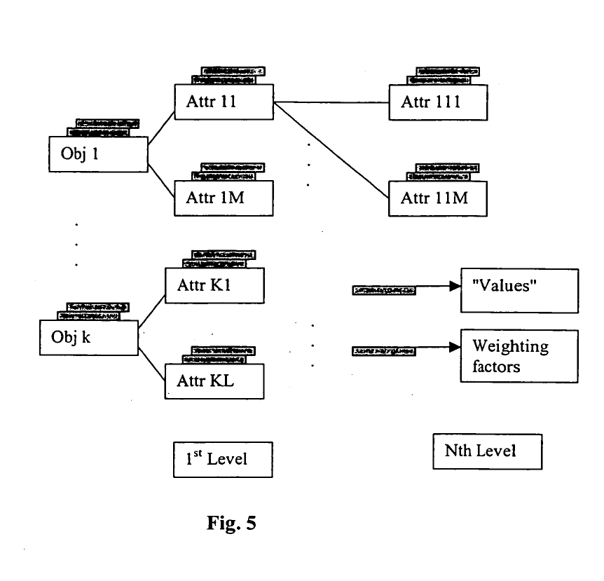

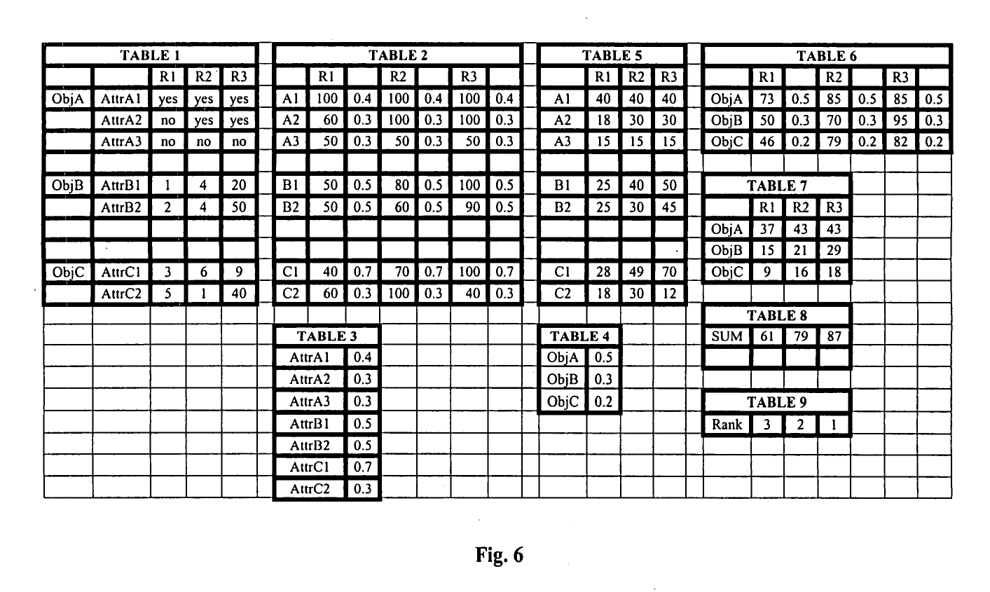

FIG. 5 shows a table that links characteristics of potential relays, and is also used as a starting point of the evaluation process (illustrated in FIG. 6).

FIG. 6 shows a realisation of an evaluation process according to a first embodiment.

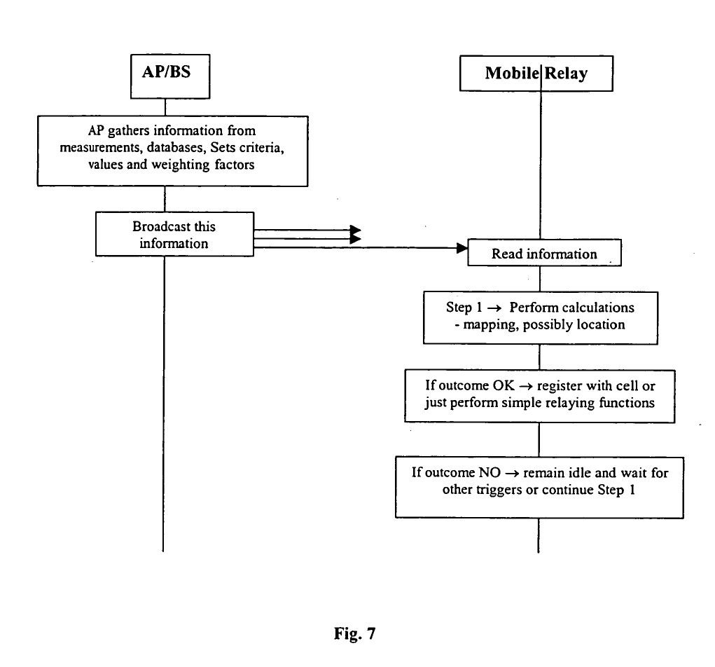

FIG. 7 shows a relay evaluation method according to a second embodiment.

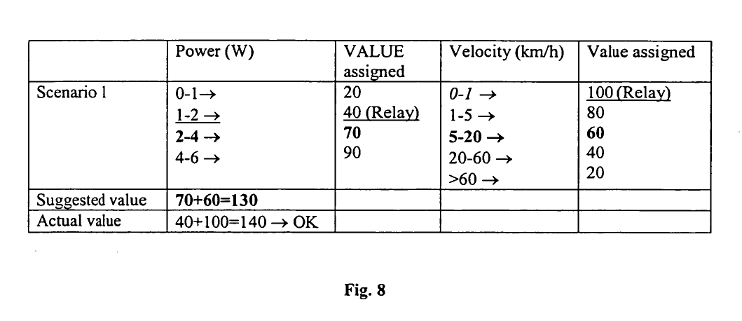

FIG. 8 shows a table illustrating a first method of evaluating a relay according to second embodiment.

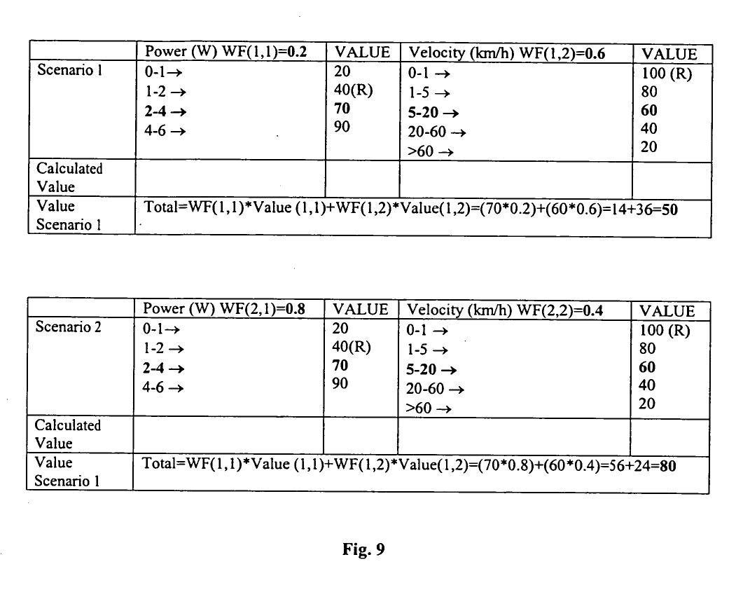

FIG. 9 shows a series of tables illustrating a second method of evaluating a relay according to a second embodiment.

A mobile communications network comprises, in part, a base station or access point 10 and a plurality of mobile handsets 20. Each base station 10 controls communication within an area, called a cell. FIG. 1 shows an example of a network architecture.

Communication is performed by sending radio wavelength signals between the base station or access point 10 and a mobile handset 20.

Base stations 20 are expensive and thus it is not practical to build them in large numbers. Therefore relay devices 16 are used to enhance coverage within the cell.

The relays 16 are extremely useful in areas with low base station power, such as at the boundaries of the cell. They are also useful to provide coverage in areas blocked by buildings (termed ‘shadowed areas’ in the art). It is known to fix relays to provide coverage in ‘shadowed’ spots. These relays are typically repeaters—devices that amplify and forward on a signal.

Mobile relays may be provided in a network. Typically a plurality of mobile relays will be used. The term ‘mobile’ includes the relays will be mobile with respect to their surroundings, as well as the mobile terminals within the cell.

The mobile relays 16 may include user terminals, e.g. mobile phones, PDAs and so on. Alternatively, the relays may be purpose built hardware and mounted on buses, coaches and the like.

An aspect of the present invention comprises a relay management function that quickly and efficiently controls which relays 16 are used within a cell. The arrangements described below relate broadly relate to two aspects of the invention. However, it will be readily apparent that the concept is to allow the adaptation of the network to evaluate and select the most appropriate relays for use in the network.

### First Embodiment

In a particular embodiment, each relay 16 is classified according to a particular criteria. This may be its type, such as fixed or mobile. If fixed, whether or not it is a high complexity device, or if it is an repeater. If the relay is a mobile relay, the classification may include what type of mobile; for example, it may be classified as a mobile terminal, or a dedicated relay.

FIG. 2 shows a table that summarizes examples of the types of relays available, and how they may be classified. Thus, as a first classification they may be separated into two categories: fixed and mobile. Sub-categories based on type and/or complexity may then be made.

Each active relay communicates with a base station controller 14 via a base transceiver station 12. Therefore, at any given moment it will be known what active relays 16 are within a particular area. By knowing the total amount of relays communicating with the base station 20, and knowing which classification each relay 16 is part of it is possible to know what percentage of each type of relay 16 is within a given area. Using the table of examples shown in FIG. 2, for fixed relays there may be 70% high complexity relays and 30% repeater types.

As a large number of relays 16 are likely to be present within a cell at any given time it is highly unlikely that each relay will be required at any given moment. Thus it is desirable to ensure that network resources are not wasted, or that interference between signals is not induced by an overcrowding of signals.

When relays communicate with the base station 20, details of their capabilities (e.g. peak power, data rate supported, power constraint) are transmitted to the base station 20. Thus the base station 20 can assess and compare the abilities of each of the relays 16 within the cell. Alternatively the relays could each be classified. Instead of each relay signalling its capabilities (which may induce delay and require the implementation of signalling requirements) it could transmit its class to the base station. Therefore, instead of using (for example) 20 bits for instructing a base station of its abilities, (for example) 5 bits could be transmitted defining the class of the relay. This approach demands that a classification of each type of relay is made in advance.

The capabilities of each detected relay 16 is reassessed at given intervals. This may be, for example, every 30 seconds. The number of mobile terminals within the cell, and the usage requirements are also monitored. As the usage requirements increase or decrease, the number of relays used within the cell is adapted.

The network may reassess the capabilities of the relays based upon triggers, rather than periodically. The triggers may be the registration or de-registration of a relay 16 with the base station 20, or it may be upon a request to the network for more resources. Alternatively a combination of periodicity and triggers may be used.

On the basis of the capabilities of each of the relays, the number and usage requirements of mobile terminals 14, the base station 10 is operable to adapt the number of relays 16 used.

Specifically the base station 20 comprises means (in the form of an algorithm) to assess the specific needs within the cell, and select the optimum relays to meet the needs. The algorithm may be located at either the base station controller 14 or at each base transceiver station 12. Generally, if the algorithm is located at the base station controller the algorithm can be used to control a larger area—a single base station controller 14 will generally control a plurality of base transceiver stations 12. Although, in an alternative arrangement, if the function is located at the base station controller 14 the algorithm may be configured to perform an evaluation of relays 16 just in a single cell. If the algorithm is located at the base transceiver station 12 the processing time is much reduced as there is one less step in the process chain.

In a preferred arrangement a number of predefined scenarios within the cell will be proposed. Each scenario will propose (at least) usage requirements for a particular area, a particular timescale and if any specific demands are needed. For example scenario 1 may relate to a small area within the cell and that a low bit rate is required, scenario 2 may relate to a large area and that high power is required and so on. A particular scenario may be a small area with high usage demands (for example to deal with the aftermath of a concert or a football match).

For each scenario, the available relays of the cell are evaluated and are rated based on the needs of the hypothetical users in that scenario. Thus the appropriate number and type of relay are predefined for each scenario. When in use, if the base station assess that the usage requirements meets a particular scenario (or most closely meets a particular scenario), the appropriate relays have already been predefined, and hence can be easily introduced to the network. The remaining relays can be withdrawn from the network to save resources and ensure that interference does nor occur. Thus, if the base station 10 ascertains that the usage demands are most similar to the demands of hypothetical scenario 7, the relays redefined as being the optimum solution for scenario 7 are introduced into the network, and the remaining relays taken out of service.

When considering the capability of each of the relays at least the following are taken into account:
What data rate is supported by the relay.
Does the relay have any power constraint. For example, if a mobile user terminal or a lap-top user used, there is the possibility that the terminal may be turned off.
The peak power that the relay can transmit at.
Does the relay support layer 1 (e.g. power control coding schemes) techniques.
Are higher layer techniques supported.
What type of carrier is the relay mounted on. For a fixed relay this will not be important. However, it is important for mobile relays; it would be undesirable for the relay to leave the cell whilst it was in use.

Additional factors need to be assessed when selecting the appropriate relays for each scenario. These include estimating whether selecting a particular number of relays will cause interference with one another.

An assessment of the location of the relays is also made. For example, if a plurality of mobile relays are each mounted on a bus, then it is important to known where the buses will be. By considering the bus routes and time-tables an estimation can be made of the buses location at any particular time. From this information, as well as road speed limits, an estimation as to the speed of bus (and hence the relay) can be made.

Within each cell, for each scenario, specific dynamic and static requirements are predetermined. Examples of types of requirements are set out in table 1 below.

TABLE 1

| | |
|---|---|
| Dynamic Requirements | Data rates requested (from users |
| | and/or specific service - eg MBMS. |
| | Mobile terminal population and |
| | dispersement. |
| | Power and coverage requirements |
| Static Requirements | Coverage area, and characteristics of |
| | said area. |
| | Power requirements. |
| | Velocity requirements. |

In order to meet certain requirements in certain scenarios, weighing factors may be attached to one or more of the above requirements. For example, if a certain scenario requires specific power requirements, only relays that are able to meet these requirements are used.

All of the above parameters may be used to set up a list of the required degrees of freedom that can be used by the evaluation algorithm to evaluate each relay. Generally, a list of first, high level objectives are defined, which are then elaborated into further, lower level objectives/attributes. An example of this arrangement is illustrated in FIG. 5.

In the present embodiment, all of the above objectives and attributes are taken into account into a process which yields the optimum relay or number of relays to cover specific needs. Two possible outcomes of the selection process could be as follows:

The relays 16 evaluated are all ranked (for example with 10 relays, from 1 to 10). The best 4 are then selected to meet the scenario requirements, the next best three are maintained in a ‘ready’ status, and the lowest three are discarded and not used.

Alternatively, a number of optimum relays are selected for each scenario. The relays are still ranked, but scenario 1 may call for using the best 4, and having the next best 2 on standby. Scenario 2 may call for using the best 3, and having the next 4 on standby and so on.

A specific realisation of an embodiment of the present invention will now be described, particularly demonstrating the realisation of a possible evaluation algorithm.

FIG. 5 shows a diagram that defines high level objectives, and, in a hierarchical manner, attributes associated with each objective. The attributes may be used to evaluate the objectives. For example, if a particular objective relates to ‘power’, then the first level attributes of the relay may be its peak power, total power availability and expected remaining functioning time at the current power value. Each relay will have a value associated with each of the attributes, and hence each of the available relays can be assessed, and the ‘power’ rating for each of the relays evaluated.

Other objectives may be what layer techniques are supported, or what level of transmission can be supported.

Table 2 set out below shows an example of three relays (R1, R2 & R3), and characteristics of each relay as assessed based on the hierarchical objective/attribute system described above.

TABLE 2

| | | | | R1 | R2 | R3 |
|---|---|---|---|---|---|---|
| objective A | Layers | attribute | L1 techniques | yes | yes | yes |
| | supported | A1 | supported | | | |
| | | attribute | L2 techniques | no | yes | yes |
| | | A2 | supported | | | |
| | | attribute | L3 techniques | no | no | no |
| | | A3 | supported | | | |
| objective B | Power | attribute | Peak power (W) | 1 | 4 | 2 |
| | | B1 | | | | |
| | | attribute | available time at | 2 | 4 | 50 |
| | | B2 | current power (hrs) | | | |
| objective C | Other | attribute | Bit rates supported | 3 | 6 | 9 |
| | | C1 | (Mbps) | | | |
| | | attribute | Velocity (km/h) | 5 | 1 | 40 |
| | | C2 | | | | |

In this example, R1 may be a PDA, R2 a laptop computer and R3 a custom relay mounted onto a bus. The objectives are set out on the left hand side of the table, and the attributes in the columns on the right hand side. The numbers represent technical characteristics associated with each objective. For example, and relay that supports layer 1 techniques a ‘yes’ value is assigned. In this example, all relays support layer 1, no relay supports layer 3 and R2 and R3 support layer 2.

Where it is possible, numeric values are used. For example, when considering the velocity of the relay, the PDA (R1) is travelling at 5 km/h, the laptop (R2) at 1 km/h and the bus-mounted relay is travelling at 40 Km/h. For attributes such as velocity and location, the base station may request that the relay provides regular up-dates in order that the information relied upon is as accurate as possible.

FIG. 6 shows a specific realisation of an evaluation algorithm. Table 1 of FIG. 6 corresponds to table 2 above.

Table 1 shows a list of the high level objectives, and specific attributes associated with each of the objectives.

Table 3 shows a weighting associated with each of the attributes. The weighting factors will vary for each scenario, and those shown in table 3 are only shown by way of an example. In any event the sum of the weighting factors for each of the attributes for each objective must total 1. In other words, the weighting for each objective must equal 1.

Table 2 shows a combination of table 1 and table 3. The attribute values in table 1 have been replaced by numeric values representing the performance of each relay with respect to one another. This may be achieved by a predetermined ‘look-up table’, or by assessing individual relays and providing a basic formula that can be applied.

Table 4 shows weighting factors for each objective (in this case: power, layers supported and others). Again the sum of each of the weighting factors must be one.

Table 5 shows the sums of the multiplications between weighting factors and attributes of table 2—i.e. the values associated with the attributes from table and the weighting factors calculated and shown in table 3.

The results for each objective are then summed, as shown in table 6. Thus the values for R1 in table 5 for the first, second and third attributes (corresponding to the first objective) are 40, 18 and 15. Thus the numeric value shown in table 6 for the first objective is 73. Table 6 also shows that the summed attributes for each objective are subjected to a weighting factor (from table 4). The results are shown in table 7. This table shows the multiplication between attributes and weighting factors for each objective for each of the objectives. Table 8 shows the combined totals of each of the objectives, and hence provides a final numeric total of how each of relays R1, R2 and R3 compare when considering three particular objectives. Table 9 shows the final ranking of the three example relays. It will be apparent that R3 is ranked first, R2 is ranked second and that R3 is ranked third.

It is also envisaged that there will be scenarios when the algorithm is bypassed, typically when very select criteria have to be met. For example, when all of the relays that are to be used are to be selected solely on the basis of their peak power attribute, then only relays with the requisite peak power need to be considered, and relays of this type are then compared. This is akin to having weighting values of 1.0 for the required attribute and 0.0 for each of the other attributes.

FIG. 4 shows an embodiment of a signalling function. For this example, it is assumed that the evaluation and management algorithm is located at the base station controller, and that the base station controller controls only one base transceiver station.

Each of the relays register with the base station controller, when they enter the cell, or are switched on. During the registration process details of the capabilities of the relays is transmitted.

Periodically the base station controller pages each of the relays (including user terminals willing to act as mobile relays) to requesting any updated information, or current status information, for example power availability.

The relays transmit their location to the base station controller. This process may be repeated as often as power and processing constraints allow.

The base station controller also requests any further information it may require from other sources—e.g. the core network.

Once all information has been collated the base station controller uses the evaluation algorithm to evaluate each of the relays and form a ranking list of each of the relays for objective.

When a new relay is activated, or enters or leaves the cell the system performs a re-evaluation after paging each of the relays for information.

The above embodiment takes particular use in a network comprising one or more mobile relays. This is because mobile relays form a dynamic environment, where the number, and characteristics, of relays may alter.

### Second Embodiment

In a further embodiment the evaluation of each of the relays 16 will occur at the relays. This arrangement avoids undesirable additional signalling. This embodiment is particularly suitable for a network comprising a plurality of mobile relays, where relays may regularly leave and enter the cell.

In this arrangement a base station 10, or access point, will evaluate usage demand by calculating its own usage demands, that of terminals associated therewith, as well as previously active relays 16 (particularly mobile relays). From these calculations the base station/access point 10 will define the needs of the cell. This may be achieve by defining scenarios that relate to pre-set usage requirements. As described in the first embodiment the relays may take the form of dedicated mobile relays, such as a relay mounted on a bus or train. However, they may take the form of a further user device such as a mobile phone 20, or lap-top. These devices generally already have an element of in-built relay functionality. However, the drain on battery power is particular drawback.

The pre-set usage requirements are converted into numerical values relating to specific parameters of the network. For example, the values may relate to minimum power requirements for a particular relay, or, in the case of a mobile relay, a particular minimum or maximum speed of travel.

The base station/access point 10 then transmits the information on a broadcast channel to each of the relays 16 in the cell. Therefore, each relay needs to synchronise to this particular channel. This arrangement can negate the need for relays to register with the base station 10, and hence saves signalling resources. However, in a preferred embodiment the relays each register with the base station 10.

Once a relay 16 has received the information transmitted from the base station or access point 10 the relay 16 will compare its own capabilities with the requirements. This process is described in more detail below.

The data transmitted to the relays from the base station 10 can be in the form of pre-set scenarios designed as models configured to cope with predetermined usage requirements. By comparing its own capabilities with the requirements for a particular scenario each of the relays 16 can effectively decide if they are suitable for use in conjunction with the current scenario.

If a particular relay fits with the scenario requirements the relay 16 may begin performing relaying functions. Alternatively the relay may first register with the base station/access point 10, and begin relaying functions once successful registration has occurred. In a preferred arrangement the relay may periodically compare its capabilities with the usage requirements to assess whether or not it still meets usage requirements. This may be because additional relays have entered the cell, or that the relay characteristics (such as location) have changed.

If a particular relay 16 does not meet the scenario requirements it may remain idle. Preferably the relay 16 will remain idle until it receives a further signal from the base station or access point 10. This signal may be, for example, further scenario requirements, as the usage demands in the cell may have changed. In an equally preferred arrangement the idle relay may retry matching its capabilities to the scenarios requirements at pre-set intervals. This may be advantageous if all of the relays are mobile. For example, if at a first instance a particular relay does not meet the requirements because there are other more suitable relays, then it will remain idle. However, as the relays are mobile they may move out of the cell. In this case the relay may become one of the most suitable in the cell. A particular arrangement where this suitable is if mobile handsets/PDAs/lap-tops 20 are being used as relays, and they are turned off by their users. The network then needs to reconfigure the most appropriate relays 16 for use in the network.

Some scenarios may be such that most relays 16 would be suitable to meet the usage requirements. Therefore it is preferable to ensure that all relays do not attempt to register with the base station/access point 10 or begin relaying functions. This will result in many unrequired signals being transmitted, and hence may cause interference.

Therefore, to avoid all relays registering with the base station, or beginning to function automatically, the base station 10 defines a limited number of relays 16 that are to function in each scenario. This information is typically transmitted with the usage requirements/scenario information.

In a preferred arrangement the base station or access point 10 may comprise a counter that counts the number of operational relays within the cell. This arrangement preferably works in conjunction with the relays 16 registering with the base station 10. Accordingly, once the required number of relays 16 is reached, no further relays are permitted to be registered with the base station in the cell, even if they fulfil the scenario requirements. When the required number of relays has been reached the base station transmits this information on the broad cast channel to all of the relays. The relays that have not been accepted for use in the network may then cease comparing their own capabilities with the scenario requirements. However, they may periodically re-compare their capabilities with scenario requirements, in case requirements alter. Alternatively, or as well as, the relays not accepted may further compare their capabilities based on external triggers.

However, as usage demands change, the optimum scenario may also change, and hence the base station or access point 10 may re-broadcast to all of the relays the required capabilities for the new scenario. Each relay 16 may then re-evaluate its capabilities against the new requirements.

A example of an algorithm operable to allow only appropriate relays to function to meet a specific scenario is described below with reference to FIG. 7.

The base station or access point 10 gathers information regarding the usage demands in the cell, and then sets criteria to ensure that the most appropriate relays are used to meet the demands. These criteria include specific values that are associated with relay characteristics, such as transmission power, velocity (for a mobile relay), area of coverage, and so on. Relay type is also an important consideration. If mobile handsets 20 are used as relays in the network there is the possibility that they may leave the network, be turned off, or cease functioning when their battery is drained.

The base station 10 broadcasts this information, together with an upper limit on the number of relays required, on a channel receivable by all of the relays 16 in the cell.

The relays, on receipt of the transmission, assess their characteristics with those required to meet the usage demands. It may be that the base station transmits specific requirements relating to particular characteristics to each of the relays, and if they do not match or better these values they are not considered suitable for use in the network to meet the present usage demands.

FIG. 8 shows a further example of how criteria of scenarios are correlated with characteristics of specific relays. This example relates to mobile relays—ie those relays that are mobile with respect to the base station and the handsets within the cell. It will be appreciated that the example shown illustrates a simplified scenario to allow for easier illustration. In this scenario (scenario 1) the two important characteristics are power and velocity. In FIG. 8 it will be seen that specific values have been associated with particular power ratings and particular velocities. For example, a power rating of 0-1 watts is assigned the rating of 20 (i.e. just a numerical value), whereas a velocity of 20-60 km/h is assigned a value of 40. Using ratings in this manner allows for a relay to calculate if it is suitable for use in the system. There may be many criteria that need to be consider, and it may be that not many relays satisfy all criteria. Therefore it is necessary to consider a ‘best fit’ for all relays. For example it may be that a specific velocity, power and supported bit rate are required. It may be acceptable if a relay has more than sufficient rating for velocity and bit rate, but not sufficient power.

Consider now a specific relay and particular usage demands in the form of a pre-defined scenario. In the example the required scenario values are shown in bold type-face. The values associated with the relay are underlined. The scenario calls for a relay with a power of 4 to 6 watts and a velocity of 5 to 20 km/h. It will be seen from FIG. 8 that these values correspond to assigned values of 70 and 60 respectively. A combined value for the scenario is therefore 130.

A specific relay has a power of 1.5 watts, and a velocity of 0.5 km/h. These characteristics correspond to values of 40 and 100 respectively. Thus a combined value for the relay is 140. In this specific example the relay does not have sufficient power; 2 to 4 watts are required, whereas the relay has only 1.5 watts (i.e. 1 to 2 watts). Hence an assigned value to 70 was requested, whilst the relay only has an assigned value of 40.

However, the relay exceeds the velocity requirements. In the example scenario a velocity of 5 to 20 km/h is acceptable. However, the relay has a speed of 0.5 km/h (i.e. 0-1 km/h), which is considered to be superior. Accordingly the value assigned to the relay's velocity rating is 100. Therefore the combined total for both velocity and power is 140. This is higher than the network required 130, and accordingly the relay is suitable for use in the cell.

In scenarios where a particular criteria is essential then a sub-optimum solution for this characteristic is not acceptable. This information may be transmitted by the base station 10. For example, a minimum power of 3 watts may be required. Even though the present relay 16 is sufficient overall, it does not meet the requirements of for power, and hence it is not suitable for use on the network.

A further variation of the present embodiment is described with reference with to FIG. 9. This arrangement allows for a particular relay to ascertain which scenario it best fits. The arrangement described in relation to FIG. 9 introduces the concept of weighting factors. FIG. 9 comprises two tables, the first relating to a first scenario and the second relating to a second scenario.

Each scenario still uses both power and velocity. However, weighting factors have been introduced into each of them. Broadly, it will be seen that in scenario 1 the velocity requirement is more important than the power requirement. The reverse is the case in scenario two.

Values are assigned in a similar manner as in the arrangement described with reference to FIG. 8. However, it will be noted that in table 1, the power characteristic has been assigned a weighting factor of 0.2, whereas the velocity characteristic has been assigned a weighting factor of 0.6.

The values in bold typeface indicate the requirements needed to meet a particular scenario. The values that are underlined indicate the values that a particular example relay has. These relay values are the same as for the previous arrangement.

In this arrangement the network is effectively classifying the relays into user groups for each scenario. Accordingly the weighting factors for each characteristic in all scenarios (e.g. velocity, power and so on) must sum to 1. There are only two scenarios in this example, but it will be appreciated that in practice there may be many more scenarios. In the example given the weighting factors associated with power are 0.2 and 0.8, i.e. a total of 1. Therefore, when defining scenarios, the most important characteristic can have the highest weighting.

From the tables in FIG. 9 it is apparent that the desired value, (or minimum value) for scenario 1 is 50, whereas for scenario 2 it is 80. The calculated value for the relay in each case is 68 and 72 respectively. Thus, comparing the values for each of the relays with the required value it will be seen that the relay is more suitable for the first scenario. Even though the calculated value of the relay is higher for the second scenario (72 instead of 68) it is more suitable for the first scenario because its calculated value (i.e. 68) is higher than the required value (i.e. 50). Whereas for the for the second scenario the relay is rated at 2, but the requirements for the system are 80. Therefore the relay is not suitable for the particular scenario.

Thus relays 16 will all have a rating value for each scenario. Therefore it is possible to rank the relays numerically. Accordingly, each scenario will have an associated list of suitable relays. Thus, it may be that in a particular scenario eight relays are required. The first eight relays on the list will be the optimum relays to meet the needs of the scenario. However, it may be that a number of scenarios are being run in the cell at any one time. Therefore, if a particular relay is not available for a scenario, because it is active within a further scenario, the next most suitable relay can be introduced in to the new scenario. In this embodiment the base station may continue to broadcast to all relays that a particular pre-defined scenario is required to meet current usage demands. The base station 10 continues to broadcast until the most optimum relays available register with the base station 10. As a hierarchical list of each of the relays 16 has been ascertained for each scenario, the relays with the highest rating for that scenario attempt to register with the base station. After a pre-determined time delays the next most optimum relays attempt to register. Thus if two relays 16 that would be the most optimum in a particular scenario do not register, after a predetermined time the next two most optimum relays attempt to register.

This arrangement negates the need for communication between the individual relays, and hence avoids additional signalling and processing in the network.

The base station/access point 10 may periodically broadcast new information, such as a change of scenario to meet new usage demands, or when mobile relays 16 leave or enter the cell. These factors may change the relay values, and particularly effect the position of relay on the numerical list. Accordingly the relays in use during a scenario may change within the duration of the scenario as more appropriate relays enter the cell, or particular relays leave the cell.

In an alternative embodiment the Relays may each assess themselves against a particular scenario. In this case the weighting factors for each characteristic in a particular scenario (e.g. velocity, power, bit rate supported) must sum to 1. However, this arrangement is less desirable because it is difficult for each of the relays to compare their abilities with the other relays. Therefore information must be transmitted to the base station 10 for processing. Accordingly further signalling and processing is required. In embodiment 1 above the processing was performed by the base station controller 14, base transceiver station 12 or access point 10, with no, or little, processing performed at the relay 16. In this embodiment it is desirable that the processing is performed by the relays. However, this arrangement results in processing being required at both the base station and the relay.

In a preferred arrangement the algorithm may also be based on the location of the relay. This is particularly important for mobile relays. Certain scenarios may be location orientated, for example due to an large gathering at a particular place, such as at a football match, or in rush hour. In this case the required location is transmitted by the base station or access point, and the relay first calculates its position (for example using triangulation techniques) to see if it fits with the scenario requirements.

It is to be understood that the above describes embodiments are set out by way of example only, and that many variations or modifications are possible within the scope of the appended claims.

1. A method of controlling a plurality of relays in communication with a base station in a cell, wherein said method comprises the steps of evaluating usage requirements in a cell, and varying the relays used in order to meet the usage demands based on the evaluation.

2. A method according to claim 1, wherein the relays used are also based on the capabilities and availability of the relays in the cell.

3. A method according to claim 1, wherein at least some of the relays are terrestrial based and are movable with respect to the cell.

4. A method according to claim 1, wherein at least some of the relays are mounted onto a vehicle.

5. A method according to claim 4, wherein the vehicle is associated with a pre-set route and schedule.

6. A method according to claim 3, wherein at least one of the mobile relays comprises a user terminal.

7. A method according to claim 6, wherein a plurality of predetermined scenarios are stored by the base station, and the most appropriate relays for each scenario are pre-selected.

8. A method according to claim 7 wherein the base station assesses the capabilities of the relays.

9. A method according to claim 8, wherein each relay is accorded a classification according to its capabilities.

10. A method according to claim 9, wherein, during initial communication with a base station, each relay communicates data indicative of its capabilities to the base station.

11. A method according to claim 7, wherein each relay assesses its own capabilities.

12. A method according to claim 1, wherein the number of relays may be altered based on change in any or all of usage requirements, relay capabilities or relay availability.

13. A method according to claim 11 wherein the capabilities of each of the relays within the cell are assessed periodically.

14. A method according to claim 13, wherein the capabilities of each of the relays are assessed at predetermined intervals.

15. A method according to claim 13, wherein the capabilities of each of the relays are assessed based on external triggers.

16. A method according to claim 15, wherein the external trigger is joining or leaving of a relay.

17. A method according to claim 11, wherein the base station broadcasts a signal on a channel receivable by each of the relays, said signal including an evaluation of current usage requirements.

18. A method according to claim 17, wherein the signal broadcast to the relays defines one of a plurality of pre-defined scenarios, and the relays store data relating to each scenario.

19. A method according to claim 18, wherein, if a relay assesses that it is suitable for use in a network, it attempts to register with the base station to be available for relaying future communications.

20. A method according to claim 7, wherein the base station broadcasts a preferred number of relays for use in a particular scenario, and only permits that number of relays to register.

21. A method according to claim 19, wherein the network assigns weighting factors for relay capabilities.

22. A method according to claim 19, wherein the location of the relays in the cell is determined, and the relays' locations are a factor in the selection of relays.

23. A method according to claim 1, further comprising a telecommunications network.

24. A mobile telecommunications network comprising at least one mobile relay mounted upon a terrestrial vehicle.

25. A mobile telecommunications network according to claim 24, wherein said vehicle is a bus, coach or train.

26. A mobile telecommunications system for a telecommunication network comprising a plurality of relays in communication with a base station, wherein the base station is operable to adaptively control the number of relays used in the network depending upon current usage requirements.
